(19) United States
(12) Patent Application Publication
(10) Pub. No.: US 2015/0360477 A1
(43) Pub. Date: Dec. 17, 2015

(54) Systems, Devices, and/or Methods for Graphene Based Imaging Process

(71) Applicant: HK INVESTMENT PRODUCTION TRADING, San Jose, CA (US)

(72) Inventors: Nguyen C. Khe, San Jose, CA (US); Hieu Dinh, San Jose, CA (US); Dien Dinh, San Jose, CA (US)

(73) Assignee: HK INVESTMENT PRODUCTION TRADING, San Jose, CA (US)

(21) Appl. No.: 14/622,865

(22) Filed: Feb. 14, 2015

Related U.S. Application Data
(60) Provisional application No. 62/010,578, filed on Jun. 11, 2014.

(51) Int. Cl. B41J 11/00; B41J 2/145

(52) U.S. Cl. CPC B41J 11/002; B41J 2/145

(57) ABSTRACT

Certain exemplary embodiments can provide a printing system comprising one or more print heads each comprising a writing energy source. The one or more print heads can be constructed to form text and/or image elements by changing the physical and/or chemical properties of a media or by jetting of ink drops to on a media. The media and ink drops can comprise graphene or graphene derivatives.

### CROSS-REFERENCES TO RELATED APPLICATIONS

This application claims priority to, and incorporates by reference herein in its entirety, pending U.S. Provisional Patent Application Ser. No. 62/010578 (Attorney Docket No. 2531-03), filed 11 Jun. 2014.

### BRIEF DESCRIPTION OF THE DRAWINGS

A wide variety of potential embodiments will be more readily understood through the following detailed description of certain exemplary embodiments, with reference to the accompanying exemplary drawings in which:

FIG. 1 is a graph of the effect of annealing temperature on bulk electrical resistivity;

FIG. 2 is a block diagram of an exemplary embodiment of a method 2000;

FIG. 3 is a schematic diagram of an exemplary xeroprinting process using soluble graphene by physical functionalization;

FIG. 4 is a graph illustrating the effect of thermal annealing on bulk electrical resistivity;

FIG. 5 is a schematic diagram of off-set printing plate process using soluble graphene by physical functionalization and/or graphene oxide;

FIG. 6 is a Fourier transform infrared spectroscopy (“FtIR”) spectra of hydrophilic graphene;

FIG. 7 is an FtIR spectra of hydrophobic graphene that has been converted from the hydrophilic graphene of FIG. 6 via laser induction at approximately 780 nanometers and/or approximately 400 nm ultraviolet (“UV”) laser;

FIG. 8 is a schematic diagram of gravure printing plate process using soluble graphene by physical functionalization and/or graphene oxide (“GO”); and

FIG. 9 is a perspective view of an exemplary embodiment of a system 9000.

### DETAILED DESCRIPTION

Certain exemplary embodiments can provide a printing system comprising one or more print heads each comprising a writing energy source. The one or more print heads can be constructed to form text and/or image elements by changing the physical and/or chemical properties of a media or by jetting of ink drops to on a media. The media and ink drops can comprise graphene or graphene derivatives.

Certain exemplary embodiments can provide a printing system comprising one or more print heads each comprising a writing energy source. The one or more print heads can be constructed to create images on a media. The media can comprise graphene or graphene derivatives.

Physically functionalized graphene (“PFG”) and physically functionalized graphene hybrid composite (“PFGHC”) have been disclosed in related U.S. patent application Ser. No. 14/047,991 (attorney docket 1200-011), which was entitled “Physically Functionalized Graphene Hybrid Composite (GHC) and its Applications” and filed on 7 Oct. 2013, and which is incorporated by reference herein in its entirety.

The PFG and PFGHC are soluble in solvent and alkaline solutions. PFG and PFGHC are electrical insulators but they can be converted into electrical conductors by thermal annealing or by irradiation with or without the presence of a reducing agent. Thermal annealing can be performed by heat sources such as infrared (“IR”), plasma, IR laser beam. Irradiation can be performed by UV light sources comprising of blue light emitting diode (“LED”, UV LED, UV laser, UV fluorescence, gamma ray, and/or X-Ray, etc.

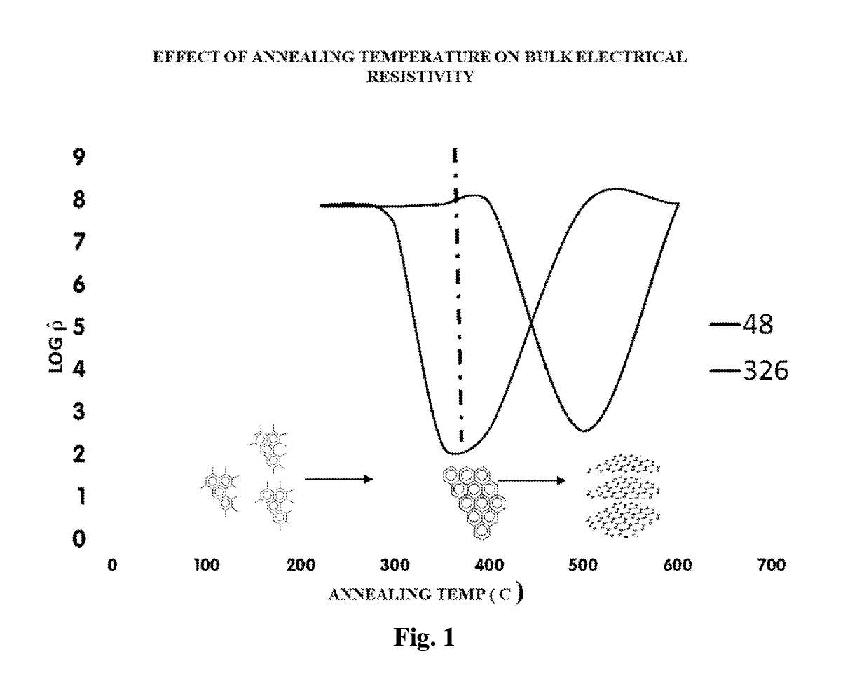

FIG. 1 is a graph of the effect of annealing temperature on bulk electrical resistivity. FIG. 1 exhibits the effect of annealing on the bulk electrical resistivity of PFG and PFGHC products from an exemplary embodiment. In the low annealing temperature zone (less than approximately 350 degrees Celsius), PFG and PFGHC products are electrical insulators due to multiple functional groups that exist on each molecule. At suitable annealing temperature (approximately 350 degrees Celsius in some embodiments) a significant decrease of electrical resistivity has been observed due to the cleavage of one or more functional groups, which renders the PFG and/or PFGHC into substantially pure graphene. However, when the annealing temperature goes significantly above the suitable annealing temperature, the bulk electrical resistivity goes up again, which may be due to the formation of a multiple layer structure. It has also been observed that different PFG and/or PFGHC compounds have different optimal annealing temperatures. An exemplary sample showed an optimal annealing temperature at approximately 350 degrees Celsius while another exemplary sample showed an optimal annealing temperature at approximately 500 degrees Celsius. The difference between electrical resistivity of annealed PFG and PFGHC products can be approximately one million times greater than non-annealed PFG and PFGHC products.

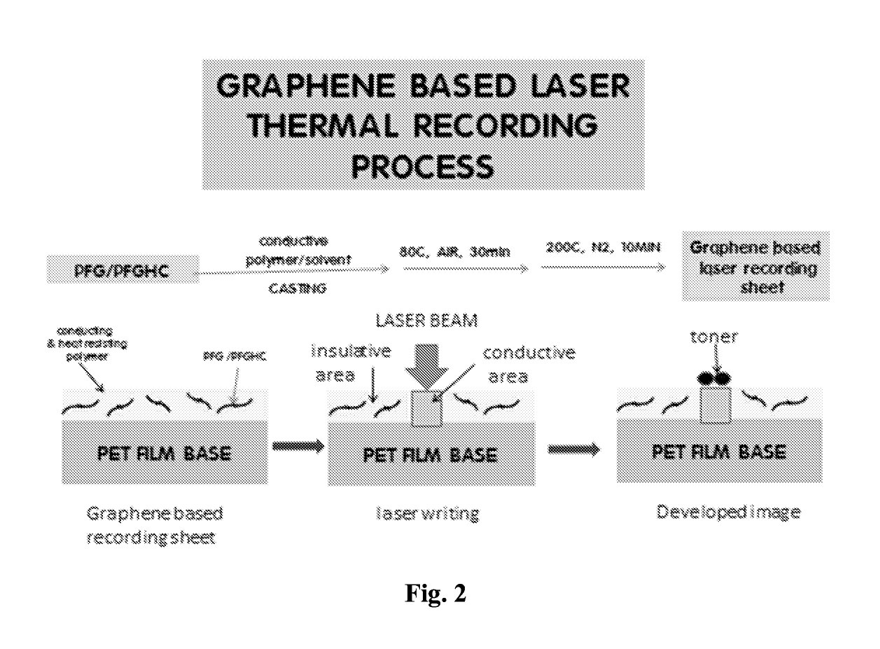

In an exemplary embodiment, the PFG and or PFGHC were embedded in a heat resistant polymer such as the polyimide Kapton® (Kapton is a registered trademark of E. I. DuPont De Nemours and Company Wilmington, Del.) and an electrical conductive polymer such as acrylonitrile butadiene styrene resin. The thin film was generated via a doctor blade (a doctor blade is a device constructed to remove excess materials from printing or coating process surfaces), and was then dried at a lower temperature to remove casting solvents. Then the cast film was exposed to a heat source, which was a thermal print head or a heat mode of a laser print head. The heat exposed area become conductive while unexposed area remained insulating, forming a latent image that can be converted into visible image by via a toning process known as electrography such as via FIG. 2.

FIG. 2 is a block diagram of an exemplary embodiment of a method 2000.

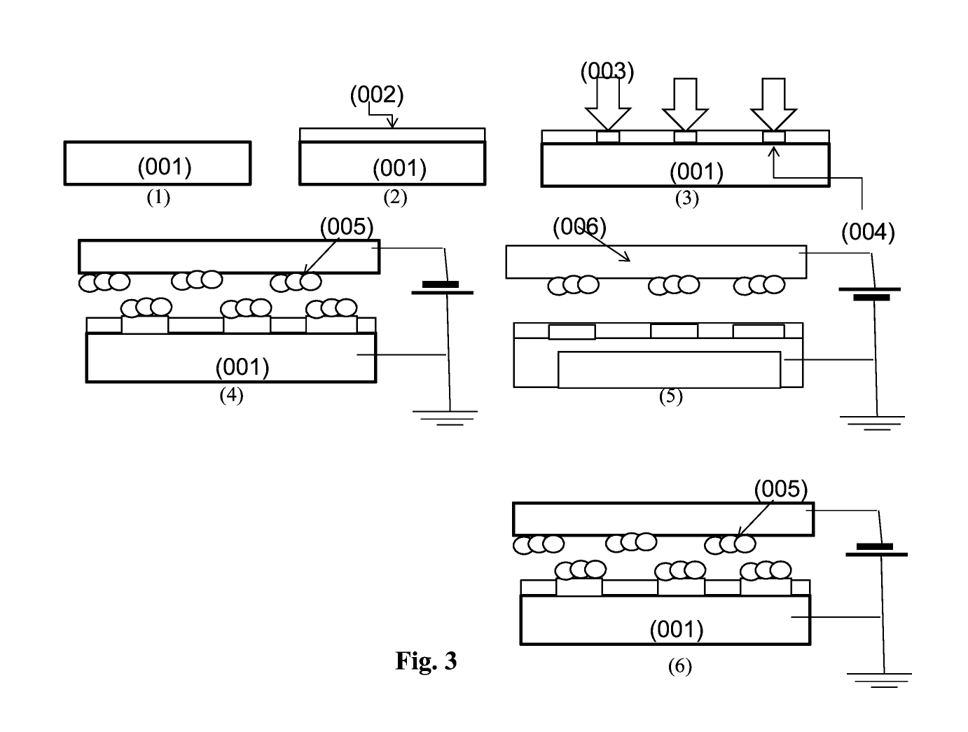

FIG. 3 is a schematic diagram of an exemplary xeroprinting process using soluble graphene by physical functionalization.

At step (1) a conductive substrate (001) is obtained. At step (2), a thin layer of soluble graphene obtained by physical functionalization process disclosed in United States Patent Application Serial Number 14/047991 was coated with an organic solvent. After being dried in an oven, all of the solvent was removed and left behind an insulative dried graphene derivative layer (002).

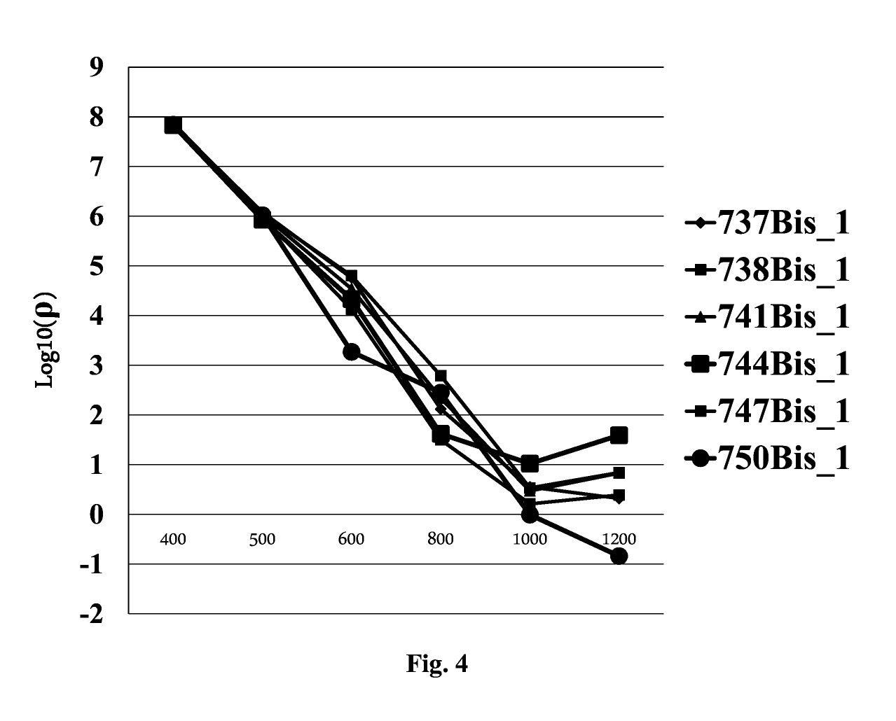

At step (3), the dried graphene derivative layer (002) was exposed to a writing source (003) which rendered portions dried graphene derivative layer (002) into electrically conductive elements (004) via heat and/or UV light induced resistivity reduction, tests for which are illustrated in FIG. 4 by another exemplary embodiment. The heat or UV light induced electro-conductivity gain formed an electrostatic charge latent image, which was substantially not optically visible to a human.

At step (4), the latent image was developed into visible image using toner (005). The process for adding toner has been described more fully in the publication “Electrophotography principles and optimization” by Merlin Scharffe, which is incorporated herein by reference in its entirety. Toner (005) temporarily adhered to surface (002) via an electrostatic charge.

At step (5), toner (005) was transferred to last destination substrate (006) via reverse bias and permanently fused to form a permanent image. Last destination substrate (006) can be plain paper, wood, metal, and/or ceramic, etc.

At step (6), after transfer of the toner to last destination substrate (006), surface (002) can be mechanically cleaned while maintaining a latent image, which can be developed again by repeating step (4) to make another copy. The latent image can maintains electro-conductivity for an extended time period after being exposed to a heat source. Following the process of FIG. 3, a single writing can make multiple copies. This printing process can also be called memory printing.

FIG. 4 is a graph illustrating the effect of thermal annealing and/or UV exposing on electrical resistivity.

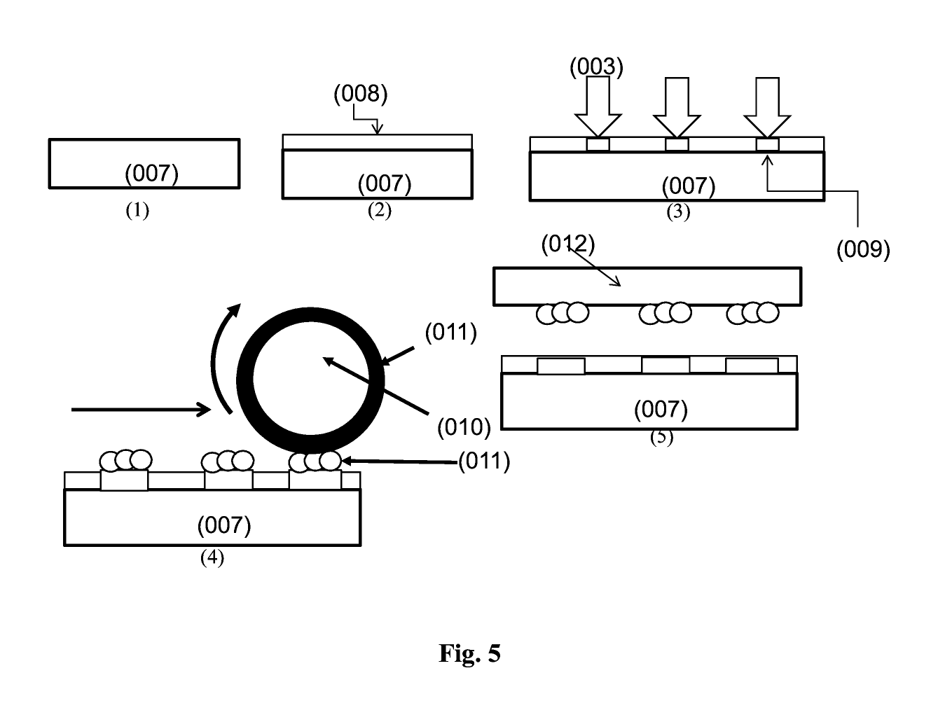

FIG. 5 is a schematic diagram of a digital offset printing plate making process using soluble graphene by physical functionalization and/or graphene oxide.

At step (1), a substrate carrying an anodized aluminum surface (007), which shows strong hydrophilicity, can be obtained.

At step (2), a thin layer of soluble graphene and/or graphene oxide can be obtained via a physical functionalization process such as disclosed in United U.S. application Ser. No. 14/047,991, and coated with an organic solvent in an alkaline aqueous solution. After being dried in an oven, substantially all of the solvent can be removed to leave behind a relatively hydrophilic graphene layer (008).

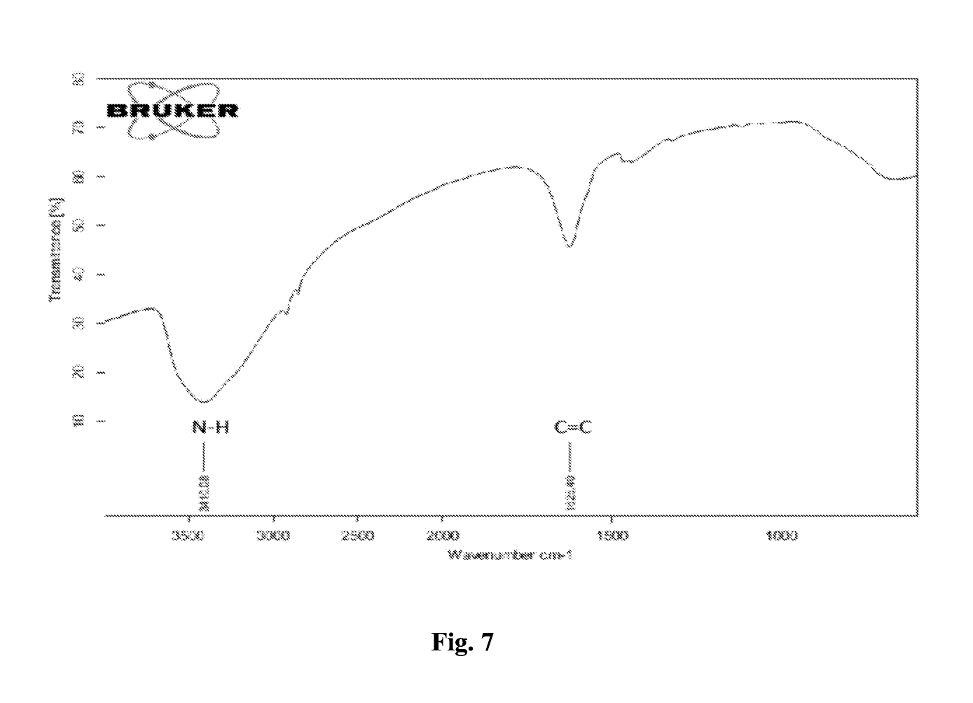

At step (3), dried hydrophilic graphene layer (008) can be exposed to a writing source (003), which can convert portions of hydrophilic surface (008) into hydrophobic surfaces (009) via heat or UV light induced hydrophobicity, the properties of which are illustrated part in FIG. 7 by another exemplary embodiment. The conversion to heat or UV light induced hydrophobicity from hydrophilicity forms a latent image, which is substantially not optically visible to a human.

At step (4), the latent image can be developed into visible image using an ink roller (010) carrying a hydrophobic ink layer (011).

At step (5), a substantially permanent image is formed via a transfer of hydrophobic ink (011) into a last destination substrate (012), which can be plain paper, wood, metal, and/or ceramic, etc.

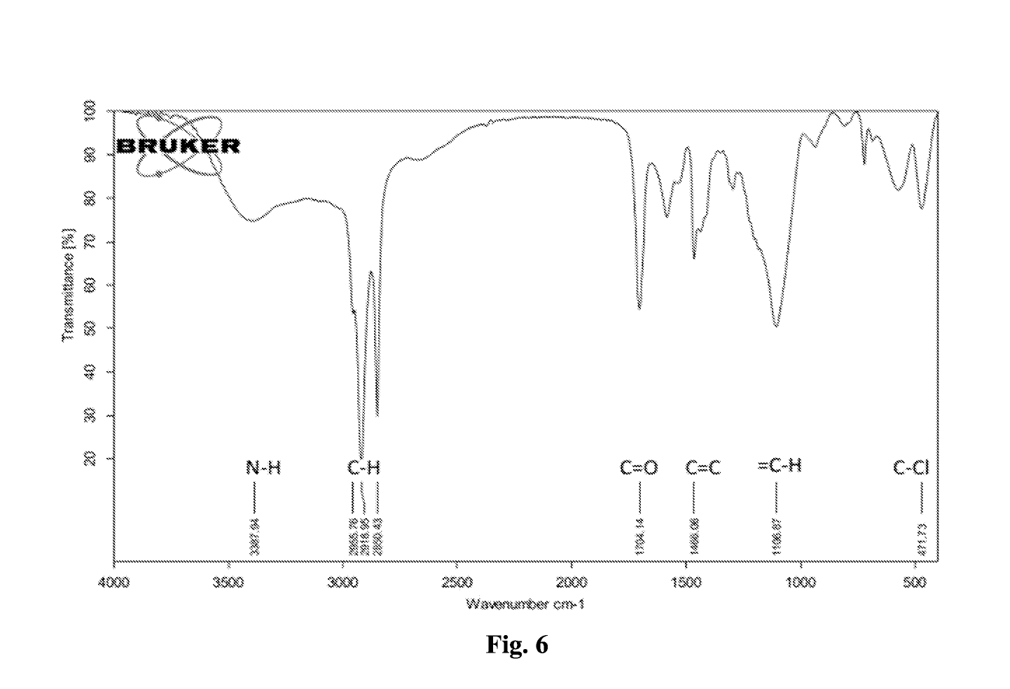

FIG. 6 is an FtIR spectrum of hydrophilic graphene. According to the exemplary embodiment, the soluble graphene shows —C═O stretch represents functionalities of graphene oxide (GO) and soluble functionalities —C═H due to aliphatic stretch beside aromatic stretch —C═C—.

FIG. 7 is an FtIR spectrum of hydrophobic graphene that has been converted from the hydrophilic graphene of FIG. 6 via a heat mode of laser induction at approximately 780 nanometers or via a UV laser at approximately 380 nanometers. The hydrophobic graphene was obtained by heating the hydrophilic graphene with an IR laser at approximately 780 nanometers. The hydrophobic graphene was also obtained by exposing the hydrophilic graphene to a UV laser at approximately 380 nanometers. The hydrophobic graphene's FtIR spectrum shows substantially no functionalities beside aromatic stretch —C═C. The heat from laser or the UV light from a UV laser source can convert hydrophilic graphene into hydrophobic graphene. This conversion can make the laser printing plate available using soluble graphene.

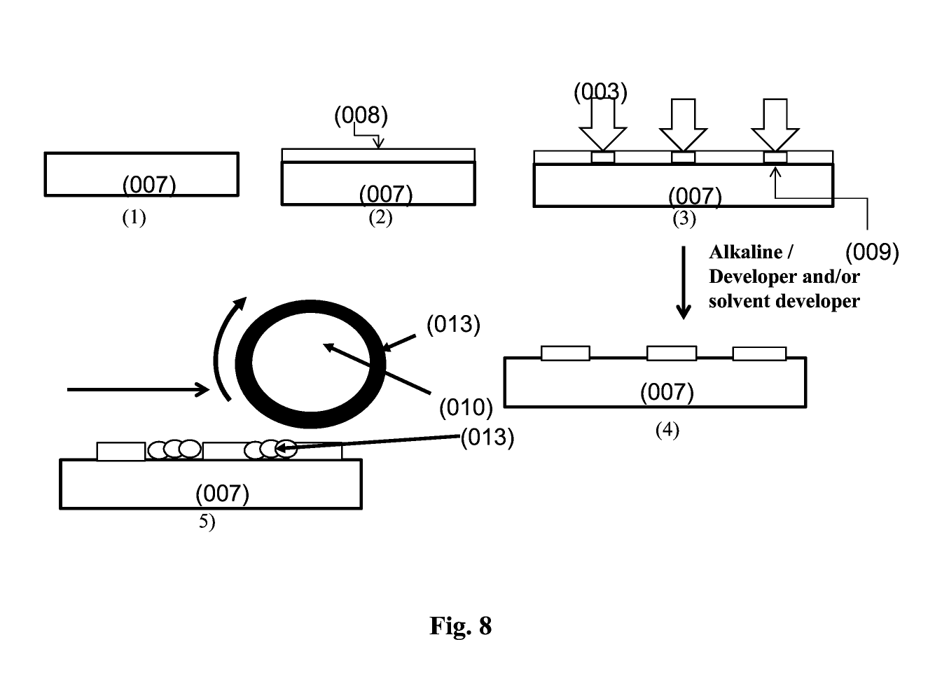

FIG. 8 is a schematic diagram of gravure printing plate process using soluble graphene by physical functionalization and/or graphene oxide (“GO”). The above described off-set printing process can be extended into a gravure printing process by developing the latent image formed via laser heat or via a UV laser by aqueous solution and/or alkaline aqueous solution, as it is described in FIG. 8. In FIG. 8, (013) is hydrophilic ink.

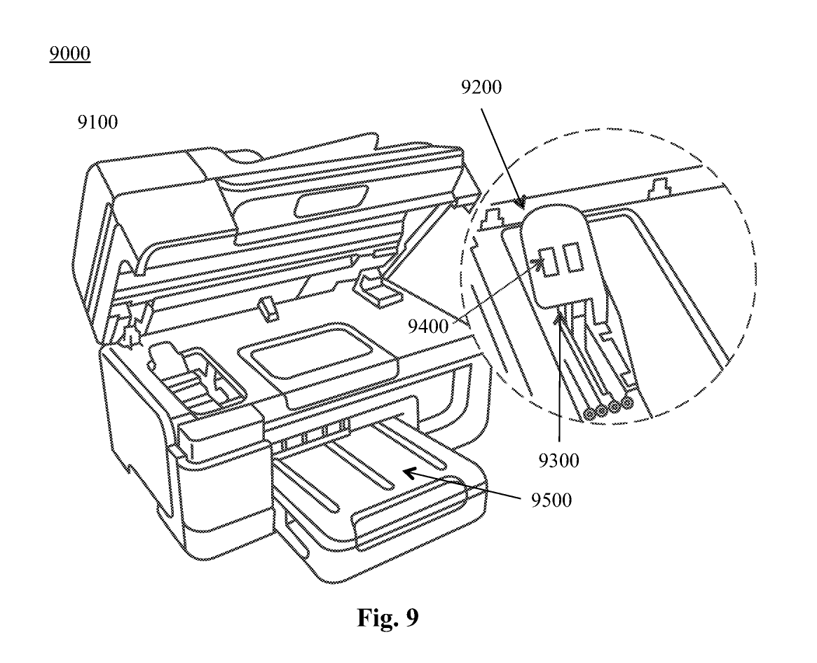

FIG. 9 is a perspective view of an exemplary embodiment of a system 9000, which can comprise a printer 9100. Printer 9100 comprises one or more print heads 9200. Each of one or more print heads 9200 can comprise a writing energy source 9300. One or more print-heads 9200 can constructed to cause a properties change on a media 9500 or ink 9400, and to form imaging elements on media 9500 utilizing ink 9400. Media 9500 or ink 9400 comprising graphene or graphene derivatives deposited on a substrate. One or more print heads 9200 can be constructed to cause a jetting of ink drops. The ink drops can comprise graphene or graphene derivatives.

One or more print heads 9200 can be constructed to produce two-dimensional and three-dimensional imaging that can be used for two-dimensional and three-dimensional printers. At least one of media 9500 or ink 9400 can comprise graphene dispersed in a liquid. The graphene can be produced via exfoliation of specific graphite. At least one of media 9500 or ink 9400 can comprise graphene soluble in a liquid media that is produced via physical functionalization. At least one of media 9500 or ink 9400 can comprise graphene oxide. Printing system 6000 can comprise at least one of a heat source, a light source, a laser, a light emitting diode, an X-Ray, a gamma-ray source, or an ultraviolet light source. Printing system 6000 can comprise at least one of an infrared laser, an ultraviolet laser, and a deep ultraviolet laser. Printing system 6000 can comprise at least one of an ultraviolet light emitting diode and a blue light emitting diode.

In certain exemplary embodiments, printing system 6000 can utilize:
thermal printing, laser printing, a light mode laser, inkjet printing, inkjet printing via a thermal inkjet or piezo inkjet printing process, nanoimprint, and/or dip pen lithography, etc.;
inkjet printing, and ink for the inkjet printing comprises soluble graphene made from physically functionalized graphene;
inkjet printing, and ink for the inkjet printing comprises graphene oxide;
inkjet printing, and ink for the inkjet printing comprises graphene produced via exfoliation of graphite in a liquid media or ink;
inkjet printing, and ink for the inkjet printing is converted into an electrically conductive form by at least one of heat, light, or chemicals;
the graphene or graphene derivative as printing media or ink in a xeroprinting process or a memory printing process;
the graphene or graphene derivative as printing media or ink in an analog or digital process of making a lithographic offset printing plate; and/or
the graphene or graphene derivative as printing media or ink in an analog or digital process of making a gravure printing plate, etc.

In certain exemplary embodiments, one or more print-heads 9200:
changes a property of a media or ink surface on the substrate that comprises the graphene or graphene derivative, the property can be one of optical density, adhesion, hydrophilicity, and/or electrical resistivity, etc.;
forms a latent image on the substrate;
forms a latent image on the substrate that is visible via a physical process or via a chemical process;
transfers a visible image onto a permanent media or ink via a physical process or via a chemical process;
are thermal print-heads, inkjet print-heads or a laser print-heads;
comprises a heat mode laser;
comprises a light mode laser constructed to induce heat via a heating element;
comprises an infrared element;
comprises a blue light emitting diode or an ultraviolet laser element;
comprises a plasma producing element; and/or
comprises a thermal inkjet configured to shoot hot elements out of an ink nozzle; etc.

In certain exemplary embodiments, one or more print heads 9200 can comprise graphene oxide and/or PFG and/or PFGHC were solidified via removal of substantially all solvents and thereby formed a three-dimensional (“3D”) solid. Print-heads 9200; which can be a heat, UV light, plasma, gamma-Ray, and/or X-ray source; were used to create 3D image from a 3D solid of soluble graphene (graphene oxide, PFG, and/or PFGHC) above described. Unexposed areas maintained solubility and were removed utilizing water or a solvent, which left behind a 3D image. Certain exemplary processes can produce prototyping 3D images.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapted to—made suitable or fit for a specific use or situation.
adhesion—a tendency of dissimilar particles or surfaces to cling to one another.
analog—relating to information represented by a continuously variable physical quantity such as spatial position or voltage that has not been converted to a numerical representation of the continuously variable physical quantity.
and/or—either in conjunction with or in alternative to.
apparatus—an appliance or device for a particular purpose.
blue—light having a wavelength between approximately 450 and 495 nanometers.
can—is capable of, in at least some embodiments.
change—to make something different from a previous state.
chemical—any substance used in or resulting from a reaction involving changes to atoms or molecules, especially one derived artificially for practical use.
chemical process—a method resulting in changes to atoms or molecules.
circuit—an electrically conductive pathway and/or a communications connection established across two or more switching devices comprised by a network and between corresponding end systems connected to, but not comprised by the network.
comprising—including but not limited to.
configure—to make suitable or fit for a specific use or situation.
connect—to join or fasten together.
convert—to transform, adapt, and/or change.
couple—to join, connect, and/or link together.
deep ultraviolet—a range of light on the violet side of the color spectrum, having a wavelength between approximately 248 and approximately 193 nanometers.
define—to establish the outline, form, or structure of.
deposit—to place substantially in an exact predetermined location.
derivative—derived from.
determine—to obtain, calculate, decide, deduce, and/or ascertain.
device—a machine, manufacture, and/or collection thereof
digital—data or information in a numerical form.
drop—a small quantity of liquid that is produced in a more or less spherical mass.
electrically conductive form—having an electrical conductivity that is greater than approximately 1,000 Siemens/meter.
electrical resistivity—ratio of electric intensity to cross-sectional area.
element—a component or constituent of a whole device or system.
exfoliation—a process via which layers of a substance or are peeled off from a substance.
gamma ray—electromagnetic radiation having a wavelength of less than approximately 10 picometers.
generate—to create, produce, give rise to, and/or bring into existence.
graphene—an allotrope of carbon having a structure of approximately one-atom-thick planar sheets of sp2-bonded carbon atoms in a honeycomb crystal lattice.
graphene hybrid composite—a substance having properties defined in
U.S. patent application Ser. No. 13/331,330, which was filed 20 Dec. 2011.
graphene oxide—a compound of carbon, oxygen, and hydrogen in variable ratios, obtained by treating graphite with oxidizers.
graphite—an electrically conductive allotrope of carbon that can be in the form of a flake, fine particle, or lump.
gravure printing plate—a plate, which can be made of copper, constructed to accept photomechanical transfer by means of a grid of closely intersecting lines that create thousands of tiny squares on the plate, which will in turn react differentially to an etching bath after the plate has been exposed to light through the positive film; varying depths of the etched cells determine the tones of the printed image, with deeper cells holding more ink (and thus printing darker) than shallow cells, which may hold no ink at all.
heat—energy that raises the temperature of an object.
heat mode laser—a laser beam system constructed to convert energy of the laser beam into thermal energy which induces physical or chemical changes in a recording medium so that detectable variations such a fusion, evaporation, deformation and phase changes are caused in the medium.
heat mode process—a method that uses thermal energy to induce physical or chemical changes.
hot—having a temperature of a sufficient level to accomplish a predetermined objective.
hydrophilicity—having an affinity for water.
image—a physical likeness or representation of something, which has been made visible.
induce—to cause.
infrared—electromagnetic radiation having a wavelength between approximately 800 nanometers and approximately one millimeter.
infrared element—a print-head component constructed to provide heat energy to the print head via infrared radiation.
ink—a liquid or paste that contains pigments and/or dyes.
inkjet—a system constructed to propel droplets of ink onto paper, plastic, or other substrates.
inkjet printing—a type of computer printing that recreates a digital image by propelling droplets of ink onto paper, plastic, or other substrates.
install—to connect or set in position and prepare for use.
jet—to forcefully shoot a stream of a liquid, gas, or small solid particles from a nozzle and/or orifice.
laser—a device that emits light through a process of optical amplification based on the stimulated emission of electromagnetic radiation.
laser printing—an electrostatic digital xerographic printing process constructed to produce text and graphics by repeatedly passing a laser beam back & forth over an electron-charged, cylindrical drum, to define a differentially-charged image; the drum then selectively collects electrically-charged, powdered ink (i.e., toner), and transfers the image to the loaded paper, which is then heated in order to permanently fuse the text/imagery.
latent image—a substantially invisible image produced by the exposure to light of a photosensitive material such as photographic film.
light—electromagnetic radiation that is visible to the human eye.
light emitting diode—a two-lead semiconductor light source comprising a pn-junction diode, which emits light when activated.
light mode laser—a laser beam system constructed to convert energy of the laser beam into light energy which induces physical or chemical changes in a recording medium so that detectable variations such a fusion, evaporation, deformation and phase changes are caused in the medium.
lithographic offset printing plate—a chemically treated plate constructed so that the printing or image area thereon has an affinity for relatively greasy ink and the non-printing area thereon has an affinity for moisture.
may—is allowed and/or permitted to, in at least some embodiments.
media—a substance upon which text or an image can be printed and/or recorded.
memory printing—producing a hard copy image from information stored on a magnetic medium.
method—a process, procedure, and/or collection of related activities for accomplishing something.
nanoimprint, dip pen lithography—a scanning probe lithography technique where an atomic force microscope tip is used to create patterns directly on a range of substances with a variety of inks
nozzle—a projecting spout from which a fluid is discharged.
optical density—a logarithmic ratio of the amount of radiation falling upon a material to the amount of radiation transmitted through the material.
permanent media and ink—text or an image that cannot be nondestructively removed once printed and/or recorded.
physical—pertaining to the substantive state of an object (e.g., solid, liquid, plasma, and/or gas, etc.).
physical functionalization—produced in accordance with a method disclosed in U.S. patent application Ser. 14/047,991.
physically functionalized graphene—graphene produced in accordance with a method disclosed in U.S. patent application Ser. No. 14/047,991.
piezo inkjet printing—a type of computer printing that recreates a digital image by propelling droplets of ink onto paper, plastic, or other substrates using a piezoelectric material in an ink-filled chamber behind each nozzle instead of a heating element; when a voltage is applied, the piezoelectric material changes shape, which generates a pressure pulse in the fluid forcing a droplet of ink from the nozzle.
plasma—one of the four fundamental states of matter, the others being solid, liquid, and gas; a plasma can be created by heating a gas or subjecting it to a strong electromagnetic field applied with a laser or microwave generator. This decreases or increases the number of electrons, creating positive or negative charged particles called ions and is accompanied by the dissociation of molecular bonds, if present.
plasma producing element—a portion of a print head constructed to generate plasma.
plurality—the state of being plural and/or more than one.
predetermined—established in advance.
print—to reproduce (e.g., text, pictures, etc.) by applying ink to paper or other material.
printer—a system which makes a persistent human-readable representation of graphics or text on paper or similar physical media utilizing some form of ink or toner.
Print head—a component of a printer constructed to form printed characters.
property—an attribute or quality of something.
process—method.
provide—to furnish, supply, give, and/or make available.
receive—to get as a signal, take, acquire, and/or obtain.
set—a related plurality.
shoot—to send forth or discharge.
soluble—having an ability to dissolve in a solid, liquid, or gaseous solvent to form a homogeneous solution in the solvent.
source—a thing from which something comes.
specific graphite—a form of graphite that shows a relatively high electrical conductivity, is relatively easily oxidized and has a bulk resistivity of approximately 0.008 ohm-centimeter.
substantially—to a great extent or degree.
substrate—a supporting material on which something is formed or fabricated.
support—to bear the weight of, especially from below.
system—a collection of mechanisms, devices, machines, articles of manufacture, processes, data, and/or instructions, the collection designed to perform one or more specific functions.
thermal—relating to, caused by, or generating heat or increased temperature.
thermal inkjet printing—a type of computer printing that recreates a digital image by propelling droplets of ink onto paper, plastic, or other substrates; wherein the print cartridges contain a series of tiny chambers, each containing a heater, all of which are constructed by photolithography; to eject a droplet from each chamber, a pulse of current is passed through the heating element, which causes a relatively rapid vaporization of the ink in the chamber to form a bubble, which causes a relatively large pressure increase, propelling a droplet of ink onto the paper.
thermal printing—a type of computer printing that recreates a digital image on paper, plastic, or other substrates; wherein the printing utilizes heat to recreate the digital image.
three-dimensional—having length, breadth, and depth.
two-dimensional—having length and breadth but substantially no depth.
ultraviolet—electromagnetic radiation having a wavelength between approximately 400 nanometers and approximately ten nanometers.
via—by way of and/or utilizing.
visible—something that can be seen by an eye of a human.
writing energy source—a portion of a printing system that provides a capacity to print.
xeroprinting—a type of computer printing based on the principle of xerography or electrophotography; xeroprinting creates multiple prints using one latent image, which had been electronically memorized on print media via ink or toner.
X-ray—electromagnetic radiation having a wavelength between approximately 0.01 nanometers and approximately ten nanometers.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A printing system, comprising:
one or more print-heads, each of said one or more print-heads comprising a writing energy source, said one or more print-heads constructed to cause a properties change on a media or ink, and to form imaging elements on said media utilizing said ink;
said media or ink comprising graphene or graphene derivatives deposited on a substrate.

2. The printing system, of claim 1, wherein:
said one or more print heads is constructed to produce two-dimensional and three-dimensional imaging that can be used for two-dimensional and three-dimensional printers.

3. The printing system, of claim 1, wherein:
at least one of said media or ink comprises graphene dispersed in a liquid, said graphene produced via exfoliation of specific graphite.

4. The printing system, of claim 1, wherein:
at least one of said media or ink comprises graphene soluble in a liquid media that is produced via physical functionalization.

5. The printing system, of claim 1, wherein:
at least one of said media or ink comprises graphene oxide.

6. The printing system, of claim 1, wherein:
said printing system comprises at least one of a heat source, a light source, a laser, a light emitting diode, an X-Ray, a gamma-ray source, or an ultraviolet light source.

7. The printing system, of claim 1, wherein:
said printing system comprises at least one of an infrared laser, an ultraviolet laser, and a deep ultraviolet laser.

8. The printing system, of claim 1, wherein:
said printing system comprises at least one of an ultraviolet light emitting diode and a blue light emitting diode.

9. The printing system, of claim 1, wherein:
said printing system utilizes thermal printing.

10. The printing system, of claim 1, wherein:
said printing system utilizes laser printing.

11. The printing system, of claim 1, wherein:
said printing system utilizes a light mode laser.

12. The printing system, of claim 1, wherein:
said printing process involves inkjet printing.

13. The printing system, of claim 1, wherein:
said printing process involves inkjet printing via a thermal inkjet or piezo inkjet printing process.

14. The printing system, of claim 1, wherein:
said printing system utilizes nanoimprint, dip pen lithography.

15. The printing system, of claim 1, wherein:
said printing system utilizes inkjet printing, and ink for said inkjet printing comprises soluble graphene made from physically functionalized graphene.

16. The printing system, of claim 1, wherein:
said printing system utilizes inkjet printing, and ink for said inkjet printing comprises graphene oxide.

17. The printing system, of claim 1, wherein:
said printing system utilizes inkjet printing, and ink for said inkjet printing comprises graphene produced via exfoliation of graphite in a liquid media or ink.

18. The printing system, of claim 1, wherein:
said printing system utilizes inkjet printing, and ink for said inkjet printing is converted into an electrically conductive form by at least one of heat, light, or chemicals.

19. The printing system, of claim 1, wherein:
said printing system utilizes said graphene or graphene derivative as printing media or ink in a xeroprinting process or a memory printing process.

20. The printing system, of claim 1, wherein:
said printing system utilizes said graphene or graphene derivative as printing media or ink in an analog or digital process of making a lithographic offset printing plate.

21. The printing system, of claim 1, wherein:
said printing system utilizes said graphene or graphene derivative as printing media or ink in an analog or digital process of making a gravure printing plate.

22. The printing system, of claim 1, wherein:
said one or more print-heads changes a property of a media or ink surface on said substrate that comprises said graphene or graphene derivative, said property one of optical density, adhesion, hydrophilicity, or electrical resistivity.

23. The printing system, of claim 1, wherein:
said one or more print-heads forms a latent image on said substrate.

24. The printing system, of claim 1, wherein:
said one or more print heads forms a latent image on said substrate that is visible via a physical process or via a chemical process.

25. The printing system, of claim 1, wherein:
said one or more print-heads transfers a visible image onto a permanent media or ink via a physical process or via a chemical process.

26. The printing system, of claim 1, wherein:
said one or more print heads are thermal print heads, inkjet print heads or a laser print heads.

27. The printing system, of claim 1, wherein:
said one or more print heads comprises a heat mode laser.

28. The printing system, of claim 1, wherein:
said one or more print heads comprises a light mode laser constructed to induce heat via a heating element.

29. The printing system, of claim 1, wherein:
said one or more print heads comprises an infrared element.

30. The printing system, of claim 1, wherein:
said one or more print heads comprises a blue light emitting diode or an ultraviolet laser element.

31. The printing system, of claim 1, wherein:
said one or more print heads comprises a plasma producing element.

32. The printing system, of claim 1, wherein:
said one or more print heads comprises a thermal inkjet configured to shoot hot elements out of an ink nozzle.

33. A printing system, comprising:
one or more print-heads each comprising a writing energy source, said one or more print-heads constructed to cause a jetting of ink drops, said ink drops comprising graphene or graphene derivatives.
